(19) United States
(12) Patent Application Publication
(10) Pub. No.: US 2025/0058285 A1
(43) Pub. Date: Feb. 20, 2025

(54) PHOTOCATALYTIC SELF-CLEANING POLYPYRROLE/TiO2-PVDF NANOCOMPOSITE BASED FILTRATION MEMBRANE

(71) Applicant: KING FAHD UNIVERSITY OF PETROLEUM AND MINERALS, Dhahran (SA)

(72) Inventors: Umair BAIG, Dhahran (SA); Abdul WAHEED, Dhahran (SA)

(73) Assignee: KING FAHD UNIVERSITY OF PETROLEUM AND MINERALS, Dhahran (SA)

(21) Appl. No.: 18/451,389

(22) Filed: Aug. 17, 2023

(51) Int. Cl. B01D 69/14; B01D 17/04; B01D 65/02; B01D 67/00; B01D 69/02; B01D 71/34; B01D 71/48; B01D 71/62; C02F 1/32; C02F 1/44; C02F 1/72

(52) U.S. Cl. CPC B01D 69/14111; B01D 17/045; B01D 65/02; B01D 67/00111; B01D 67/0013; B01D 67/00793; B01D 69/02; B01D 69/145; B01D 71/34; B01D 71/48; B01D 71/62; C02F 1/32; C02F 1/444; C02F 1/725; B01D 2325/02834; B01D 2325/06; B01D 2325/10; B01D 2325/36; C02F 2101/32; C02F 2303/16; C02F 2305/10

(57) ABSTRACT

A filtration membrane including a first layer comprising a polyester terephthalate nonwoven fabric, a second layer comprising a polyvinylidene fluoride matrix doped with a polyvinylpyrrolidone and titanium dioxide nanoparticles, and a third layer comprising a polypyrrole polymer. A method of making the membrane is also described. The membrane of the present disclosure is self-cleaning under visible light irradiation conditions.

### STATEMENT OF ACKNOWLEDGEMENT

The inventors acknowledge the support provide by the Interdisciplinary Research Center for Membranes and Water Security, King Fahd University of Petroleum and Minerals, Saudi Arabia, through Project INMW2313.

### BACKGROUND

### Technical Field

The present disclosure is directed to a photocatalytic self-cleaning filtration membrane, particularly a photocatalytic self-cleaning polypyrrole/TiO₂-poly(vinylidene fluoride) (PVDF) nanocomposite-based filtration membrane for separating an oil and water mixture.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Rapid industrial development has led to several challenges for humans in the current era of urbanization and industrialization. Oil spills and the generation of immense quantities of emulsified oily wastewater, including produced water (oil in water; oil/water (O/W) emulsions), are one of these challenges. Treating such wastewater streams will not only generate clean water, but will also minimize environmental pollution. Furthermore, recovering clean water from O/W emulsions will lower the stress on dwindling freshwater resources. Many approaches, such as dissolved air floatation, chemical methods, bioremediation, gravity filtration through meshes, and the use of sponges and sorbents, have been explored for the separation of oil from O/W emulsions.

Superhydrophobic and superoleophilic materials preferably allow oil to pass through while water is repelled. Although such materials have been seen to be efficient for O/W separation, the excessive fouling of such materials due to oil deposition in the material is a challenge that lowers separation performance. A TiO₂-gelatine-based aerogel that able to remove both cationic and anionic dyes but also able to separate oil from oil/water-free mixtures and O/W emulsions [Jiang, J., Zhang, Q., Zhan, X. & Chen, F. A multifunctional gelatin-based aerogel with superior pollutants adsorption, oil/water separation, and photocatalytic properties. Chem. Eng. J. 358, 1539-1551 (2019), incorporated herein by reference in its entirety]. Further, the TiO₂-gelatin-based aerogel was also able to degrade the adsorbed pollutants leading to regeneration of the aerogel.

Another variant of surface wettability of materials is superhydrophilicity/hydrophilicity and underwater superoleophobicity, which allows water to permeate through while oil is repelled. This mode of surface wettability is advantageous as the superhydrophilic/hydrophilic surface does not allow the oil to wet the surface, and hence evidence of oil fouling and deposition on the material surface is minimized.

A mesh membrane made up of cupric phosphate (Cu₃(PO₄)₂) having a superhydrophilic nature and a water contact angle (WCA) of zero possessed an underwater superoeolephobic nature with an oil contact angle (OCA) of >158° which allowed water to pass through the mesh while oil was rejected with a permeate containing 2 ppm oil [Zhang, Z. et al. Cupric Phosphate Nanosheets-Wrapped Inorganic Membranes with Superhydrophilic and Outstanding Anticrude Oil-Fouling Property for Oil/Water Separation. ACS Nano. 12, 795-803 (2018), incorporated herein by reference in its entirety]. A superhydrophilic sponge having underwater superoleophobic surface wettability is known [Yan, S. et al. Environmentally Safe and Porous MS@TiO2@PPy Monoliths with Superior Visible-Light Photocatalytic Properties for Rapid Oil-Water Separation and Water Purification. ACS Sustain. Chem. Eng. 8, 5347-5359 (2020), incorporated herein by reference in its entirety]. The sponge was developed through the in-situ growth of TiO₂ nanocrystals followed by vapor deposition of polypyrrole (PPy), leading to multifunctional MS@TiO2@PPy. The sponge was able to separate oil dispersed in O/W mixtures with a permeate flux reaching 9549 L m⁻² h⁻¹ (LMH).

Incorporation of nanoparticles (NPs), such as TiO₂, in membranes and/or meshes adds a photocatalysis advantage to membranes and meshes. Certain NPs, such as TiO₂, BiVO₃, and Fe₂O₃, which have been used as traditional photocatalysts, are excited by ultraviolet (UV) irradiation due to a wide band gap of 3.2 eV (TiO₂) [Susanto, H. et al. Incorporation of Nanoparticles as Antifouling Agents into PES UF Membrane. Mater. Today Proc. 13, 217-223 (2019); and Baig, U., Gondal, M. A., Ilyas, A. M. & Sanagi, M. M. Band gap engineered polymeric-inorganic nanocomposite catalysts: Synthesis, isothermal stability, photocatalytic activity, and photovoltaic performance. J. Mater. Sci. Technol. 33, 547-557 (2017), both of which are incorporated herein by reference in their entirety]. The use of such NPs in real-life applications is low as natural sunlight contains 3%-5% UV light when it reaches the earth's surface. The incorporation of photocatalysts in a porous matrix has been seen to be advantageous due to lesser chances of agglomerated NPs, high light absorption, and a lower possibility of catalyst leaching during filtration experiments. Furthermore, the inclusion of conjugated polymers, such as PPy, on NPs (e.g., TiO₂@PPy) can also augment photocatalytic ability of the NPs and, consequently, the material in which the NPs are embedded and lead to the degradation of pollutants. NPs have been incorporated in sponges, which have lesser application in practice compared to membranes, as sponges are applied under gravity-driven separation and membranes may be applied under pressure-driven separation [Wang, C. F., Huang, H. C. & Chen, L. T. Protonated Melamine Sponge for Effective Oil/Water Separation. Sci. Reports 2015 51 5, 1-8 (2015), incorporated herein by reference in its entirety]. Gravity separation may work for small volume mixtures of oil and water; however, its application using larger volumes of feeds is not feasible. The gravitational force with large volumes of feed can overcome resistance offered by sponges and meshes, which can over-turn the separation capability of such materials. Hence, there is a need to develop membranes containing photocatalytic NPs that are decorated in a stable manner in the membrane and which can work under pressure and exhibit properties including superhydrophilic/hydrophilic surfaces, superoleophobic underwater activity, and photocatalysis. Accordingly, an object of the present disclosure is to provide a photocatalytic hydrophilic nanocomposite membrane for use in oil/water separation.

### SUMMARY

In an exemplary embodiment, a filtration membrane is described. The filtration membrane includes a first layer including a polyester terephthalate nonwoven fabric; a second layer including a polyvinylidene fluoride matrix doped with a polyvinylpyrrolidone and titanium dioxide nanoparticles; and a third layer including a polypyrrole polymer.

In some embodiments, one or more amine group of the polypyrrole polymer is bonded to one or more oxygen atom of the titanium dioxide nanoparticles.

In some embodiments, the membrane is a porous structure with pores from 0.5 to 10 micrometers (μm) in diameter.

In some embodiments, the third layer is in the form of globules wherein the globules have an average diameter of 0.5 to 3 μm.

In some embodiments, the membrane has a rate of flux from 20 to 300 liters per square meter per hour (L m⁻² h⁻¹) at a pressure from 0.5 bar to 5 bar.

In some embodiments, the membrane has an average surface roughness of 80 to 90 nanometers (nm).

In some embodiments, the membrane has a root mean square roughness of 110 to 120 nm.

In some embodiments, the membrane has a water contact angle of 50 to 60°.

In some embodiments, the membrane has an oil contact angle in air of about 0° and an oil contact angle in water of at least 160°.

In some embodiments, the membrane has a rejection profile of oils of at least 99% by weight.

In some embodiments, the membrane is self-cleaning under visible light irradiation conditions.

In some embodiments, the visible light irradiation is for at least a time of 1 hour.

In some embodiments, a method of filtration is described. The method includes contacting the filtration membrane with an oil-water composition. The oil-water composition includes at least water and one or more oil. The method further includes collecting a permeate passing through the filtration membrane to obtain a purified composition have a reduced amount of the oil.

In some embodiments, the oil in the oil-water composition is one or more of motor oil, diesel oil, and crude oil.

In some embodiments, the method further includes wetting the filtration membrane with water before contacting the filtration membrane with the oil-water composition.

In some embodiments, a mechanism of the method of filtration includes coating the membrane with a layer of water before rejecting the oil.

In some embodiments, the membrane was made by a process of dissolving a polyvinylidene fluoride and a polyvinylpyrrolidone in an organic solvent to form a polyvinylidene fluoride dope solution; and further casting the polyvinylidene fluoride dope solution onto the polyester terephthalate nonwoven fabric. The polyester terephthalate nonwoven fabric is prefixed to a glass plate. The method further includes immersing the polyester terephthalate nonwoven fabric cast with the polyvinylidene fluoride dope solution in a first solution of titanium dioxide nanoparticles in an alcohol to form a first material; and further contacting the first material with a second solution of a pyrrole monomer, a sodium dodecyl sulfate, and an inorganic salt in water to form the filtration membrane.

In some embodiments, the titanium dioxide nanoparticles are incorporated into the polyvinylidene matrix in a phase inversion process.

In some embodiments, the polypyrrole polymer is deposited on the titanium dioxide nanoparticles in a chemical oxidation process to form a polymeric active layer of the polypyrrole polymer on the titanium dioxide nanoparticles.

In some embodiments, the method further includes irradiating the membrane with visible light thereby photo-catalytically degrading oil deposited on the membrane during the collecting to form carbon dioxide.

These and other aspects of the non-limiting embodiments of the present disclosure will become apparent to those skilled in the art upon review of the following description of specific non-limiting embodiments of the disclosure in conjunction with the accompanying drawings. The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure (including alternatives and/or variations thereof) and many of the attendant advantages thereof will be readily obtained as the same becomes better understood by reference to the following detailed description when considered in connection with the accompanying drawings, wherein:

FIG. 1 is a flowchart depicting a method of making a filtration membrane, according to certain embodiments;

FIG. 2A is a schematic illustration depicting various phases of membrane fabrication using phase inversion and oxidative polymerization, according to certain embodiments;

FIG. 2B is a schematic illustration depicting a proposed reaction and structure of polypyrrole (PPy)@TiO₂/poly(vinylidene fluoride) (PVDF) membrane, according to certain embodiments;

FIG. 3A depicts an Attenuated Total Reflectance-Fourier Transform Infrared (ATR-FTIR) spectra of a bare TiO₂/PVDF membrane and the PPy@TiO₂/PVDF membrane, according to certain embodiments;

FIG. 3B shows a fingerprint region of the ATR-FTIR spectra of FIG. 3A, according to certain embodiments;

FIG. 4 depicts in air water contact angle (WCA), in air oil contact angle (OCA), and underwater OCA of the PPy@TiO₂/PVDF membrane, according to certain embodiments;

FIG. 5A shows two-dimensional (2D) atomic force microscopy (AFM) images of the bare TiO₂/PVDF membrane, respectively, according to certain embodiments;

FIG. 5B shows three-dimensional (3D) AFM images of the bare TiO₂/PVDF membrane, according to certain embodiments;

FIG. 5C shows 2D AFM images of the PPy@TiO₂/PVDF membrane, according to certain embodiments;

FIG. 5D shows 3D AFM images of the PPy@TiO₂/PVDF membrane, according to certain embodiments;

FIG. 6A-FIG. 6C show scanning electron microscope (SEM) micrographs of the bare TiO₂/PVDF membrane, at different magnifications, according to certain embodiments;

FIG. 6D-FIG. 61 show SEM micrographs of the PPy@TiO₂/PVDF membrane, at different magnifications, according to certain embodiments;

FIG. 7A and FIG. 7B show Energy-dispersive X-ray (EDX) spectroscopic images of the bare TiO₂/PVDF membrane, at different magnifications, according to certain embodiments;

FIG. 7C and FIG. 7D show EDX images of the PPy@TiO₂/PVDF membrane, at different magnifications, according to certain embodiments;

FIG. 8A shows an EDX layered image of the bare TiO₂/PVDF membrane, according to certain embodiments;

FIG. 8B shows elemental mapping analysis of the bare TiO₂/PVDF membrane, showing carbon, according to certain embodiments;

FIG. 8C shows elemental mapping analysis of the bare TiO₂/PVDF membrane, showing oxygen, according to certain embodiments;

FIG. 8D shows elemental mapping analysis of the bare TiO₂/PVDF membrane, showing fluorine, according to certain embodiments;

FIG. 8E shows elemental mapping analysis of the bare TiO₂/PVDF membrane, showing titanium, according to certain embodiments;

FIG. 8F shows an EDX layered image of the PPy@TiO₂/PVDF membrane, according to certain embodiments;

FIG. 8G shows elemental mapping analysis of the PPy@TiO₂/PVDF membrane, showing carbon, according to certain embodiments;

FIG. 8H shows elemental mapping analysis of the PPy@TiO₂/PVDF membrane, showing oxygen, according to certain embodiments;

FIG. 8I shows elemental mapping analysis of the PPy@TiO₂/PVDF membrane, showing fluorine, according to certain embodiments;

FIG. 8J shows elemental mapping analysis of the PPy@TiO₂/PVDF membrane, showing titanium, according to certain embodiments;

FIG. 8K shows elemental mapping analysis of the PPy@TiO₂/PVDF membrane, showing nitrogen, according to certain embodiments;

FIG. 9 is a bar graph showing variation of pure water flux of the PPy@TiO₂/PVDF membrane with varying applied feed pressures, according to certain embodiments;

FIG. 10A is a bar graph showing variation of pure water flux of the PPy@TiO2/PVDF membrane with various feeds of motor oil (MO), diesel oil (DO), and crude oil (CO), according to certain embodiments;

FIG. 10B depicts separation efficiency of the PPy@TiO2/PVDF membrane for the feeds of MO, DO, and CO, according to certain embodiments;

FIG. 11A is a bar graph showing a variation of pure water flux of the PPy@TiO₂/PVDF membrane with varying concentrations of the DO in water emulsion at 2 bar of pressure, according to certain embodiments;

FIG. 11B is a bar graph showing separation efficiency of the PPy@TiO₂/PVDF membrane with varying concentrations of the DO in water emulsion at a pressure of 2 bar, according to certain embodiments;

FIG. 12A-FIG. 12C shows micrographs of oil/water emulsions of MO, DO, and CO in water, respectively, according to certain embodiments;

FIG. 12D-FIG. 12F show photographic images of feed (turbid sample vials) and permeate collected during oil/water emulsion separation with the PPy@TiO₂/PVDF membrane (clear sample vials) for the oil/water emulsions of MO, DO, and CO in water, respectively, according to certain embodiments;

FIG. 12G-FIG. 121 shows micrographs of permeates collected during oil/water emulsion separation with the PPy@TiO₂/PVDF membrane with different oil emulsions, namely, MO, DO, and CO in water, respectively, at a concentration of 200 ppm at a pressure of 2 bar, according to certain embodiments;

FIG. 13 is a schematic illustration showing a proposed mechanism of oil/water emulsion separation by the PPy@TiO₂/PVDF membrane, according to certain embodiments;

FIG. 14A is an image establishing self-cleaning potential of the PPy@TiO₂/PVDF membrane by underwater OCA, according to certain embodiments;

FIG. 14B shows ATR-FTIR spectra of a fresh, fouled, and cleaned PPy@TiO₂/PVDF membrane, according to certain embodiments;

FIG. 15 is a schematic illustration showing a proposed photocatalytic self-cleaning mechanism of the PPy@TiO₂/PVDF membrane, according to certain embodiments.

### DETAILED DESCRIPTION

In the following description, it is understood that other embodiments may be utilized, and structural and operational changes may be made without departure from the scope of the present embodiments disclosed herein.

Reference will now be made to specific embodiments or features, examples of which are illustrated in the accompanying drawings. In the drawings, whenever possible, correspond or similar reference numerals will be used to designate identical or corresponding parts throughout the several views. Moreover, references to various elements described herein are made collectively or individually when there may be more than one element of the same type. However, such references are merely exemplary in nature. In may be noted that any reference to elements in the singular may also be constructed to relate to the plural and vice-versa without limiting the scope of the disclosure to the exact number or type of such elements unless set forth explicitly in the appended claims. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the term “membrane” refers to a porous structure that is capable of separating components of a homogeneous or heterogeneous fluid. A membrane may be a layer of varying thickness of semi-permeable material that may be used for solute separation as a transmembrane pressure is applied across the membrane. A degree of selectivity may be based on membrane composition, charge, and porosity. Membranes may have symmetric or asymmetric pores, wherein a membrane with asymmetric pores have variable pore diameters. Membranes may be used for microfiltration, ultrafiltration, nanofiltration, and reverse osmosis process. In particular, “pores” in the context of the present disclosure indicate voids allowing fluid communication between different sides of the material. Pores may have a varying pore size, pore size distribution, and pore morphology, such as pore shape and surface roughness. The pores may be made up of a network of interconnected channels. More particular in use when a homogeneous or heterogeneous fluid is passed through the membrane, some components of the fluid may pass through the pores of the membrane into a “permeate stream,” while some components of the fluid can be retained by the membrane and can thus accumulate in a “retentate,” and/or some components of the fluid can be rejected by the membrane into a “rejection stream.” The homogeneous or heterogeneous fluid that enters the membrane may be referred to herein as a “feed stream” or a “feed.” Membranes can be of various thicknesses with homogeneous or heterogeneous structures. Membranes can be in the form of flat sheets or bundles of hollow fibers. Membranes can also be in various configurations including, but not limited to, spiral wound, tubular, hollow fiber, and other configurations identifiable to a skilled person upon a reading of the present disclosure. Membranes may also be classified according to their pore diameter. Membranes can be neutral or charged, and particle transport can be active or passive. The latter can be facilitated by pressure, concentration, and chemical or electrical gradients of the membrane process.

As used herein, the term “filtration” refers to the mechanical or physical operation or process which can be used for separating components of homogeneous or heterogeneous solutions. Filtration may use a filter medium to separate components of homogeneous and heterogenous solutions. The filter medium may be a physical separator, such as a membrane, a chemical separator or gradient, an electrical separator or gradient, and any separator or gradient known in the art for separating solutions. Filtration may be used to separate solids from liquids, solids from gases, and/or liquids from other liquids. Filtration may be gravity-driven, pressure-driven, and/or vacuum-driven.

As used herein, the term “surfactant” refers to a chemical compound that decreases the surface tension or interfacial tension between two liquids, a liquid and a gas, or a liquid and a solid. In an embodiment, the surfactant may refer to an organic compound that, when added to a liquid, changes the properties of that liquid at a surface. In some embodiments, the surfactant may be an organic compound that, when added to a surface, may change the properties of that surface. In an embodiment, the surfactant may function as an emulsifier, a wetting agent, a detergent, a foaming agent, a dispersant, a combination thereof, and the like. In some embodiments, the surfactant may be ionic, nonionic, amphiphilic, and the like. The surfactant may be polar or nonpolar. A surfactant molecule may include one or more hydrophilic units attached to one or more hydrophobic units. The hydrophobic unit of the surfactant may include a hydrocarbon chain, which can be branched, linear, aromatic, or a combination thereof. In some embodiments, the surfactant may comprise polymeric units. In some embodiments, a surfactant may be added to an aqueous phase and the surfactants may form aggregates, such as spherical micelles, cylindrical micelles, lipid bilayers, and the like. Aggregate shape and size may be influenced by the chemical composition, structure, and amount of the surfactant.

Aspects of the present disclosure are directed to a polymeric-inorganic nanocomposite filtration membrane for mitigating membrane fouling, preferably fabricated with self-cleaning properties. The filtration membrane, also referred to as a membrane, comprising photocatalytic TiO₂ nanoparticles (NPs) in a polyvinylidene fluoride (PVDF) matrix was fabricated by wet phase inversion to form a TiO₂/PVDF membrane. To enhance the separation potential and photocatalytic activity of TiO₂ NPs, polypyrrole (PPy) was grown on the membrane through oxidative polymerization leading to an active layer composed of PPy@TiO₂ nano-photocatalyst and an overall PPy@TiO₂/PVDF membrane.

The membrane was thoroughly characterized by attenuated total reflectance Fourier transform infrared (ATR-FTIR) spectroscopy, contact angles (CAs), atomic force microscopy (AFM), scanning electron microscopy (SEM), energy dispersive X-ray (EDX) spectroscopy, elemental mapping analysis, and was further evaluated for its potential in treating water-containing emulsified oily feed. For this purpose, feeds containing different oils, such as motor oil (MO), diesel oil (DO), and crude oil (CO), were treated with the filtration membrane of the present disclosure. A separation efficiency of >99% was observed for the tested oils with the membrane of the present disclosure. The membrane was further tested for its photocatalytic self-cleaning activity, where a fouled PPy@TiO₂/PVDF membrane was exposed to solar-simulated visible light. The fouled membrane was cleaned due to the photocatalytic properties of the membrane of the present disclosure. The surface features of the cleaned membrane resembled that of the pristine PPy@TiO₂/PVDF membrane, suggesting that the membrane of the present disclosure demonstrates photocatalytic self-cleaning properties.

A filtration membrane for the separation of oil-water mixtures is described. In some embodiments, the membrane may be used for oil and water separation, water treatment, desalination, pharmaceutical filtration, and the like. The membrane of the present disclosure may have a varying thickness between 0.5 to 50 μm, preferably 1 to 20 μm, and more preferably 2 to 10 μm. Oil and water mixtures are generally observed in wastewater, produced water, or seawater after an oil spill, rendering the water unfit for human/animal life. The membrane of the present disclosure allows for the separation of oil from water by selectively enabling the passage of water leaving behind the oil when the oil and water mixture is passed through the membrane. To bring about such a separation it is desirable for the membrane to have a hydrophilic character.

The membrane includes a first layer. The first layer includes polyester terephthalate (PET) fabric which serves as a support. The first layer may have a varying thickness. The PET fabric may be woven or non-woven. In a preferred embodiment, the PET fabric is non-woven. The first layer may optionally be reinforced on a glass surface and/or a glass plate. The glass surface may be optionally surface activated to facilitate the attachment of the PET fabric onto the glass surface/plate.

The membrane further includes a second layer that is in contact with the first layer. The second layer is a polymeric layer. The second layer may have a varying thickness. The polymeric layer includes a polyvinylidene fluoride (PVDF) matrix doped with polyvinylpyrrolidone (PVP) and titanium dioxide (TiO₂) nanoparticles. The PVDF, PVP, and TiO₂ NPs in the second layer may interact with one another via dipole-dipole forces and London dispersion forces. In an embodiment, one or more polar covalent bonds of the PVDF may interact with one or more polar covalent bonds of the PVP to form dipole-dipole interactions within the second layer. In another embodiment, one or more nonpolar covalent bonds of the PVP may interact with one or more nonpolar covalent bonds of the PVDF to form London dispersion interactions within the second layer. The Ti-O bonds in the TiO₂ nanoparticles have both ionic and covalent character. In an embodiment, the polar covalent Ti-O bonds in the TiO₂ nanoparticles may interact with polar and nonpolar covalent bonds in PVP and PVDF to form dipole-dipole interactions and London dispersion interactions, respectively. The second layer may interact with the first layer via dipole-dipole forces and London dispersion forces. In an embodiment, one or more polar covalent bonds of the PET in the first layer may interact with one or more polar covalent bonds of PVDF, PVP, TiO₂ NPs, and a combination thereof in the second layer to form dipole-dipole interactions between the first and second layer. In an embodiment, one or more nonpolar covalent bonds of the PET in the first layer may interact with one or more nonpolar covalent bonds of PVDF, PVP, TiO₂ NPs, and a combination thereof in the second layer to form London dispersion interactions between the first and second layer. Doping the PVDF matrix with organic/inorganic additives (nanoparticles) preferably increases the effectiveness of the membrane.

Suitable examples of inorganic additives that can be used to enhance the hydrophilicity of the membrane include SiO₂, silica, zirconium dioxide, ZnO, CuO, Fe₂O₃, and/or a combination thereof. In some embodiments, these additives may be used, optionally, along with TiO₂ nanoparticles. In certain other embodiments, these additives may be used, optionally, instead of the TiO₂ nanoparticles. In some embodiments, organic additives may be used as well in the PVDF matrix. Suitable examples of organic additives include cellulose acetate phthalate (CAP), polyvinyl alcohol (PVA), graphene oxide, polyethylene glycol (PEG), graphene oxide, chitosan, or combinations thereof. In some embodiments, the organic additives can be used optionally instead of PVP. In some embodiments, the organic additives can be used in combination with PVP. The weight percentage of the organic and the inorganic additives in the polymer matrix, PVDF, can be varied based on the end application. In some embodiments, the weight ratio of PVDF to PVP is in a range of 1:5 to 5:1, preferably 4:1 to 1:4, preferably 3:1 to 1:3, and more preferably about 3:1. In an embodiment, the inorganic additives, such as the titanium dioxide nanoparticles are incorporated into the PVDF matrix by any method known in the art—for example, by phase inversion or electrostatic spinning. In a preferred embodiment, the TiO₂ NPs are incorporated into the PVDF matrix by phase inversion. Phase inversion is a process in which membranes and the like are fabricated. Phase inversion is a process of controlled polymer transformation from a liquid phase to solid phase. Phase inversion refers to the process by which a polymer solution inverts into a three-dimensional network. Phase inversion is performed by removing solvent from a liquid polymer solution, leaving a porous, solid membrane. Techniques such as precipitation from vapor phase, precipitation by controlled evaporation, thermally induced phase separation, and immersion precipitation may be used to synthesis membranes. In an embodiment, phase inversion via immersion precipitation may be used to as a membrane preparation method. In an embodiment, a polymer plus solvent (polymer solution or dope solution) is cast on a supporting layer and then submerged in a coagulation bath containing a nonsolvent. The solvent and nonsolvent exchange promote precipitation of the polymer. Phase inversion may be carried out through reducing the temperature of the solution, immersing the polymer solution into an anti-solvent, exposing the polymer solution to a vapor of anti-solvent, evaporating the solvent in atmospheric air, evaporating the solvent at high temperature, and a combination thereof. A combination of phase separation and mass transfer affect the membrane structure. A mean pore diameter and pore diameter distribution may be varied and dependent on a rate at which phase inversion occurs. In a preferred embodiment, PVDF and PVP are mixed in an organic solvent, preferably a polar aprotic solvent, and cast onto the PET fabric. In an embodiment, PVDF is stirred in the polar aprotic solvent for a time of 1-12 hours, preferably, 2-10 hours, preferably 5-7 hours, and more preferably about 6 hours, and at a temperature of 30-70° C., preferably 40-60° C., and more preferably about 50° C. In a preferred embodiment, the PVDF dissolved in the polar aprotic solvent >80%, preferably >85%, preferably >90%, preferably >95%, and more preferably 100%. In an embodiment, PVP is mixed is a solution of PVDF and polar aprotic solvent for a time of 6-48 hours, preferably, 12-36 hours, preferably 20-26 hours, and more preferably about 24 hours, and at a temperature of 30-70° C., preferably 40-60° C., and more preferably about 50° C. In an embodiment, the weight ratio of PVDF and PVP to polar aprotic solvent is in a range of 1:1 to 1:10, preferably 1:2 to 1:8, preferably 1:3 to 1:5, and more preferably about 1:4. In a preferred embodiment, the polar aprotic solvent is dimethylformamide (DMF). In a preferred embodiment, TiO₂ NPs are incorporated into the PVDF matrix by phase inversion for a time of 1-4 hours, preferably 2-3 hours, and more preferably about 2 hours. In an embodiment, TiO₂ NPs are incorporated into the PVDF matrix by replacing polar aprotic solvent molecules.

The self-cleaning photocatalytic activity of the membrane is thought to be imparted by the presence of TiO₂ nanoparticles. The TiO₂ nanoparticles are capable of forming electron-hole pairs in the presence of electromagnetic radiation, particularly ultraviolet light, or visible light. In a preferred embodiment, the TiO₂ nanoparticles are capable of imparting photocatalytic activity to the membrane under visible light. In an embodiment, the membrane is self-cleaning under visible light irradiation conditions. Self-cleaning is possible, provided the membrane is irradiated for at least 1 hour.

The TiO₂ nanoparticles are amorphous or crystalline, preferably crystalline. In an embodiment, the TiO₂ nanoparticles may exist in any form (e.g., anaphase or rutile form). In a preferred embodiment, the predominant phase of the TiO₂ nanoparticles in the membrane is anaphase, preferably >50%, preferably >60%, preferably >65%, preferably >70%, preferably >75%, preferably >80%, preferably >85%, preferably >90%. In an embodiment, the TiO₂ nanoparticles may be 100% anatase form.

The substrate further includes a third layer that is in contact with the second layer. The third layer may interact with the second layer via dipole-dipole forces, hydrogen bonding forces, and London dispersion forces. The third layer is an active layer of the membrane. The third layer includes a polypyrrole (PPy) containing repeating/polymeric units of pyrrole. In some embodiments, organic polymers having other repeating/polymeric units of organic compounds may be used as well in the third layer. Suitable examples of organic compounds include thiophenes, anilines, acetylenes, the like, and combinations thereof that may be reacted or polymerized to form polythiophenes, polyanilines, polyacetylenes, the like and combinations thereof. In some embodiments, the organic polymers can be used optionally instead of PPy. In some embodiments, the organic polymers can be used in combination with PPy. The weight percentage of the organic polymers in the third layer can be varied based on the end application. The thickness of the third layer may vary based on end application. In some embodiments, the PPy is deposited on the titanium dioxide nanoparticles in a chemical oxidation process, such as oxidative polymerization, to form a polymeric active layer of the PPy on the TiO₂ nanoparticles. The active layer is formed by dipole-dipole interactions, including hydrogen bonds, between one or more amines from the PPy to one or more oxygen atoms of the TiO₂ nanoparticles. In an embodiment, a hydrogen atom of one or more amines of the polypyrrole of the third layer may interact with one or more oxygen atoms of the TiO₂ nanoparticles of the second layer via hydrogen bonds. In some embodiments, every other amine of the polypyrrole in the third lay may be bound to every other TiO₂ molecule in the second layer. In an embodiment, a hydrogen atom of one or more amines of the polypyrrole of the third layer may interact with a fluorine atom of one or more C—F groups of the PVDF of the second layer via hydrogen bonds. In an embodiment, a hydrogen atom of one or more amines of the polypyrrole of the third layer may interact with a nitrogen atom of one or more amines of the polypyrrole of the third layer via hydrogen bonds. In an embodiment, one or more nonpolar covalent bonds of the polypyrrole of the third layer may interact with one or more nonpolar covalent bonds of the polypyrrole of the third layer via London dispersion forces. In some embodiments, the polymeric active layer covers at least 50%, preferably 60%, more preferably 80%, and yet more preferably more than 95% on the TiO₂ nanoparticles. The third layer is in the form of globules. The globules have an average diameter of 0.5 to 3 μm.

PPy may be synthesized by chemical or electrochemical means. Chemical synthesis may involve mixing a strong oxidizing agent (typically FeCl₃ or any other oxidizing agent conventionally used in the art) with a monomeric or oligomeric solution of pyrrole to form the PPy.

The porosity of the membrane may play an important role in the filtration performance of the filtration membrane. It is, therefore, desirable for the membrane to have a specific pore size which may allow for the passage of specifically sized molecules while rejecting the others. The membrane of the present disclosure is porous, having pores with an average diameter in a range of 0.5 to 10 μm.

The fabricated membrane comprises an irregular, rough, bumpy, pitted, and rutted surface morphology. The membrane comprises pores in a range of 0.5 to 10 μm, preferably 0.5 to 1 μm, preferably 1 to 5 μm, preferably 5 to 10 μm, and any value therebetween. The membrane may comprise multiple pores with varying sizes. The surface of the membrane (the third layer) comprises globules with an average diameter of 0.5 to 3 μm, preferably 0.5 to 1 μm, preferably 1 to 2 μm, preferably 2 to 3 μm, any value therebetween. The membrane may comprise multiple globules with varying sizes. The globules may be agglomerations of smaller globules. The globular agglomerations may comprise 2-100 globules, preferably 5-50 globules, and preferably 10-25 globules. The globules may be singular. The globules may form a layer on the surface of the membrane, the inside of the pores of the membrane, and a combination thereof.

The membrane has a rate of flux from 20 to 300 L m⁻² h⁻¹ at a pressure from 0.5 bar to 5 bar, an average surface roughness of 80 to 90 nm, a root mean square roughness of 110 to 120 nm, a water contact angle of 50 to 60°, an oil contact angle in air of about 0° and an oil contact angle in water of at least 160°.

Another aspect of the present disclosure relates to a method of filtration. Wetting the membrane is a first step in preparing the filtration membrane. Wetting the filtration membrane pores may eliminate dry pathways where foulants, like particles, gels, or bubbles, could pass through, resulting in poor separation performance. In an embodiment, the membrane is submerged in a polar solvent to wet the membrane at least 80%, preferably at 90%, preferably 95%, and more preferably 100%. After wetting, the membrane is contacted with an oil-water composition. The oil-water composition includes one or more oils. Suitable examples include, toluene, hexane, cyclohexane, dichloromethane, plant oil, isooctane, lubricating oil, motor oil, crude oil, diesel oil, gasoline, and any oil known in the art. Although the examples herein provided refer to the use of motor oil, diesel oil, and crude oil, it may be noted that the membrane of the present disclosure is effective in separating any oil and water mixture, particularly low molecular weight oils/aliphatic oils. During the separation process, the membrane is coated with water, which forms a hydration layer, before rejecting the oil. The hydrophilic hydration layer allows for selectively passing water molecules through the membrane, leaving behind the oil. The membrane of the present disclosure demonstrates a rejection profile of oils of at least 99% by weight. After filtration, the permeate passing through the filtration membrane is collected. The collected permeate is a purified permeate having a reduced amount of oil. In an embodiment, the purified permeate has <1% of oil, preferably <0.5% oil, and preferably about 0% oil by weight.

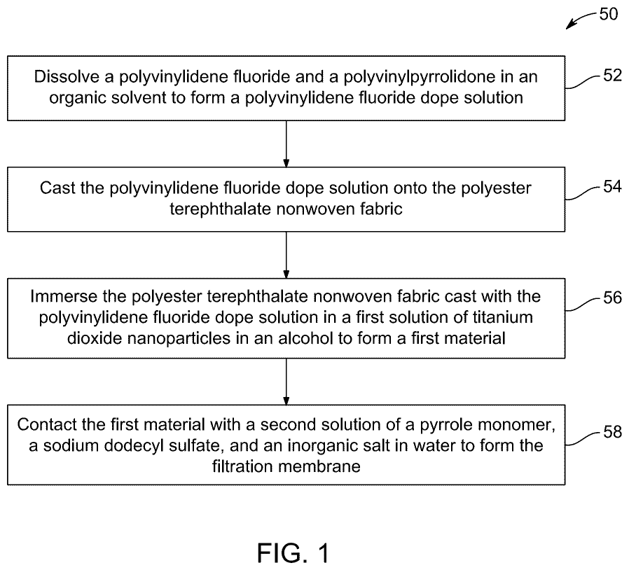

FIG. 1 illustrates a schematic flow chart of a method 50 of making the membrane. The order in which the method 50 is described is not intended to be construed as a limitation, and any number of the described method steps may be combined in any order to implement the method 50. Additionally, individual steps may be removed or skipped from the method 50 without departing from the spirit and scope of the present disclosure.

At step 52, the method 50 includes dissolving a polyvinylidene fluoride (PVDF) and a polyvinylpyrrolidone (PVP) in an organic solvent to form a polyvinylidene fluoride dope solution. A dope solution is a homogeneous thermodynamically stable polymer solution formed by a polymer or a copolymer, solvent, solvent mixture, and/or additive(s).

The choice of the polymer and the organic solvent play a role in influencing the morphology and properties of the membrane. In a preferred embodiment, the PVDF and PVP are mixed in an organic solvent in a weight ratio range of 1:5 to 1:10, preferably 1:2 to 1:8, preferably 1:3 to 1:5, and more preferably about 1:4. The organic solvent may be an alcohol, ether, amide, amine, or mixtures thereof. Suitable examples of alcohol include ethanol, butanol, isopropanol, and the like. In an embodiment, the solvent is an amide solvent (e.g., dimethylformamide (DMF)). In some embodiments, other polymers, such as PVA, polyethersulfone (PES), chitosan, polysulfone (PSF), and the like, or minerals, can be used as well to prepare the dope solution.

In an embodiment, the PVDF was initially dissolved in an organic solvent, DMF, under stirring at a temperature range of 40-60° C., preferably 45-55° C., and more preferably at about 50° C. for 4-8 hours, preferably 5-7 hours, preferably for about 6 hours. In an embodiment, PVP is then added to the PVDF solution at a temperature range of 40-60° C., preferably 45-55° C., and more preferably at about 50° C. for 14-28 hours, preferably 15-25 hours, preferably 20-24 hours, and more preferably for about 24 hours. In an embodiment, carrying out this mixing at this temperature allows for dissolution of PVDF and PVP from 80-100%, preferably 90-100%, preferably 95-100%, and more preferably 100% in the organic solvent. The high solubility of the polymer in the organic solvent yields a membrane with desired porosity.

At step 54, the method 50 includes casting the polyvinylidene fluoride (PVDF) dope solution onto the polyester terephthalate (PET) nonwoven fabric. Optionally, other polyester polymers may be used as well, independently or in combination with the PET nonwoven fabric. Suitable examples of polyester polymers include, but are not limited to, polybutylene terephthalate, polytrimethylene terephthalate, polyethylene naphthalate, polylactic acid, polybutylene succinate, and a copolymer thereof In some embodiments, a biodegradable polymer may be used as well, independently or in combination with the PET nonwoven fabric. Examples of biodegradable polymers include, but are not limited to, polylactic acid, polybutylene succinate, polycaprolactone, polyethylene succinate, polyglycolic acid, and polyhydroxybutyrate. In an embodiment, the casting is performed by a phase inversion process.

In a preferred embodiment, the polyester polymer is a polyester terephthalate nonwoven fabric. The polyester terephthalate nonwoven fabric may be prefixed to a glass plate to increase its tensile strength and/or the rigidity of the corresponding membrane. To facilitate the attachment of the polyester terephthalate nonwoven fabric onto the glass plate, the glass plate may optionally be surface activated by any of the methods conventionally known in the art.

At step 56, the method 50 includes immersing the polyester terephthalate nonwoven fabric cast with the polyvinylidene fluoride dope solution in a first solution of titanium dioxide nanoparticles in an alcohol to form a first material. The immersing in the first solution may occur for a time of 1-4 hours, preferably, 2-3 hours, and more preferably for about 2 hours. The first solution of titanium dioxide nanoparticles in an alcohol may be a homogeneous solution, a heterogeneous solution, a suspension, and the like. Suitable examples of alcohol include methanol, ethanol, isopropanol, butanol, or the like. In a preferred embodiment, the alcohol is isopropanol. The TiO₂ nanoparticles are amorphous or crystalline, preferably crystalline. In an embodiment, the TiO₂ nanoparticles may exist in any form—for example, anaphase or rutile form. In a preferred embodiment, the predominant phase of the TiO₂ nanoparticles in the membrane is anaphase, preferably >50%, preferably >60%, preferably >65%, preferably >70%, preferably >75%, preferably >80%, preferably >85%, preferably >90%. In an embodiment, the TiO₂ nanoparticles maybe 100% anatase form. The titanium dioxide nanoparticles are incorporated into the polyvinylidene matrix in a phase inversion process. In an embodiment, the first material may be placed in a water bath to promote the removal of organic solvent for a time of 6-48 hours, preferably 12-36 hours, preferably 20-30 hours, and more preferably about 24 hours.

At step 58, the method 50 includes contacting the first material with a second solution comprising a pyrrole monomer, a sodium dodecyl sulfate (SDS), and an inorganic salt in water to form the filtration membrane. The filtration membrane may be referred to as a PPy@TiO₂/PVDF/PET or PPy@TiO₂/PVDF membrane. The pyrrole monomer may be added to the second solution as a neat pyrrole or by mixing the pyrrole in a suitable solvent—for example, methanol. The pyrrole monomer concentration may be in the range of 0.01 to 2 M in the second solution.

SDS may be used to activate the first material and enhance the wettability of the membrane. In some embodiments, the concentration of the SDS in the second solution is in a range of 0.05-30 wt. %, preferably 0.5-10 wt. % of the total weight of the second solution. The immersion of the first material into the second solution may be carried out at room temperature—preferably at a temperature range of 20-37° C., and more preferably 20-25° C. SDS may be used as a wetting agent or a surfactant to enhance wettability without altering the inherent characteristics of the first material. In some embodiments, other surfactants that can improve the wettability may also be used—for example, sodium dodecyl benzenesulfonate (SDBS), cetyltrimethylammonium bromide (CTAB), or a combination thereof. In some embodiments, the other surfactants may be used optionally instead of SDS. In some embodiments, the other surfactants can be used in combination with SDS.

The inorganic salt is an oxidizing agent. Examples of strong oxidants include the cations Fe³⁺, Cu⁻²⁺, and Ce⁴⁺. In a preferred embodiment, the inorganic salt is FeCl₃. The polymerization of the pyrrole monomer on the first material was adjusted by regulating the concentration of the inorganic salt, temperature, and the polymerization period. In a preferred embodiment, the polymerization period is 6-48 hours, preferably 12-36 hours, preferably 20-30 hours, and more preferably about 24 hours. The PPy grows on the first material by contacting the first material with the second solution to form the membrane. The prepared membrane may be washed with oil and/or alcohol, such as methanol, for further applications.

The filtration membrane of the present disclosure may be adapted for use selected from a group consisting of oil and water separation, water treatment, desalination, and pharmaceutical filtration. The membrane may be effective in separating oils, such as motor oil, diesel oil, and crude oil, when adapted for use in oil and water separation.

The membrane of the present disclosure demonstrates >99% separation efficiency when used for the separation of an oily mixture (motor oil, diesel oil, crude oil) from water. The permeate pure water flux was found to be dependent upon feed pressure and the nature of oil in the feed. Motor oil showed the highest permeate flux of 29 LMH, followed by diesel oil and crude oil, with permeate fluxes of 25 LMH and 17 LMH, respectively, at a pressure of 2 bar.

The membrane of the present disclosure demonstrates photocatalytic self-cleaning characteristics when exposed to visible light. Oil deposited on the membrane may be degraded by irradiating the membrane with visible light thereby photo-catalytically breaking down the oil deposited on the membrane to form carbon dioxide and water via oxidation and reduction reactions.

### Examples

The following examples describe and demonstrate exemplary embodiments of the polypyrrole/TiO₂—PVDF nanocomposite-based filtration membrane as described herein. The examples are provided solely for the purpose of illustration and are not to be construed as limitations of the present disclosure, as many variations thereof are possible without departing from the spirit and scope of the present disclosure.

### Materials

Polyvinylidene fluoride (PVDF; [CH₂CF₂]b), polyvinylpyrrolidone (PVP; C₆H₉NO), dimethylformamide (DMF; C₃H₇NO), pyrrole (C₄H₄N), ferric chloride (FeCl₃), and sodium dodecyl sulfate (SDS) were acquired from Sigma (USA). Organic solvents such as methanol, isopropanol, and ethanol (Fisher Scientific) were purchased from a local supplier.

### Fabrication of Polymeric/Inorganic Nanocomposite Ultrafiltration Membrane

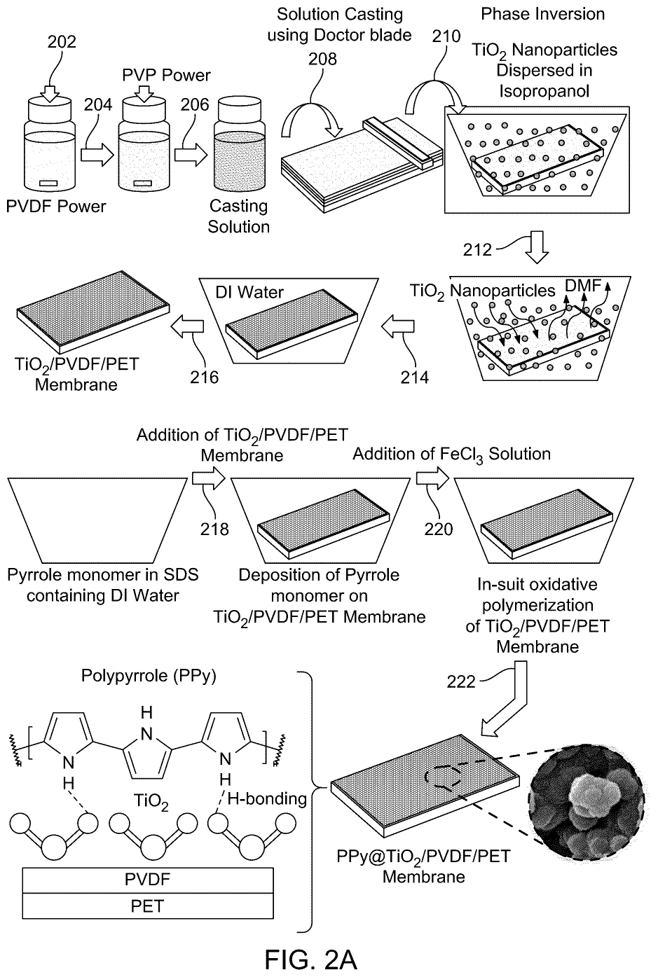

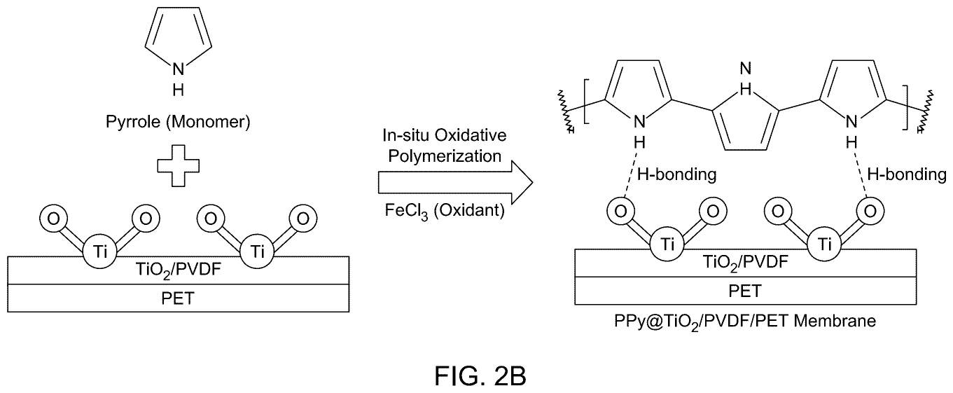

Referring to FIG. 2, a schematic illustration depicting the fabrication of the membrane is described. The membrane was fabricated by phase inversion, followed by in-situ oxidative polymerization. PVDF dope solution was prepared by dissolving 15 g of PVDF, 5 g of PVP, and 80 g of DMF. Initially, PVDF was added in DMF (202), and stirring was continued at 50° C. for 6 hours, leading to the complete dissolution of PVDF. Upon dissolving PVDF, PVP was added (204), and stirring was continued for 24 h at 50° C. Then the solution was allowed to stand at room temperature to allow the entrapped air bubbles to escape and form the PVDF dope solution (casting solution) (206). The dope solution was cast onto a polyester terephthalate (PET) nonwoven fabric prefixed on a glass plate (208) and immediately immersed in an isopropanol coagulation bath containing TiO₂ nanoparticles (210). Phase inversion was continued for 2 hours to allow the TiO₂ NPs to incorporate in the PVDF membrane while allowing complete demixing of DMF used in the dope solution preparation (212). To enhance the removal of DMF from the PVDF membrane, the isopropanol in the coagulation bath was replaced with DI water (214), and the membrane was dipped for 24 hours leading to TiO₂/PVDF/PET membrane (216).

The next step was depositing the polypyrrole (PPy) layer on the TiO₂/PVDF/PET membrane through oxidative polymerization. The pyrrole monomer was dissolved in an SDS-containing DI water solution. The SDS was added to enhance the wettability of the membrane. The TiO₂/PVDF/PET membrane was dipped in a pyrrole-containing solution for 2 hours (218). Upon saturation of the TiO₂/PVDF/PET membrane with pyrrole monomer, FeCl₃ was added to the solution leading to the polymerization of pyrrole, forming a polypyrrole layer on the TiO₂/PVDF/PET membrane (220). The polymerization of pyrrole was continued for 24 hours (222). The fabricated polymeric/inorganic nanocomposite membrane was identified as PPy@TiO₂/PVDF/PET (PPy@TiO₂/PVDF) membrane.

### Characterization of PPy@TiO₂/PVDF Membrane

Membrane characterization techniques were used to characterize the fabricated TiO₂@PVDF support and PPy@TiO₂/PVDF membrane. In order to determine the functional groups in the support and the PPy@TiO₂/PVDF membrane, attenuated total reflectance Fourier transform infrared (ATR-FTIR) spectroscopy spectra were recorded. For the sake of recording the spectra, completely dried membrane samples were exposed to a laser in ATR mode by using a spectrometer (Nicolet iS50, Thermo, 168 Third Avenue. Waltham, MA, USA 02451). Similarly, surface wettability features of the support and PPy@TiO₂/PVDF membrane were determined by contact angle (CA) measuring goniometer (KRUSS, DSA25E; manufactured by KRUSS, Hamburg, 85 Borsteler Chaussee, Germany). For the sake of measuring CAs, dried pieces of the membranes were cut and fixed on a glass slide using double-sided tape. Then an appropriate droplet (2 μL), either water or oil, was dropped on the membrane surface. The surface roughness of the membranes was measured by atomic force microscopy (AFM) (Agilent 5500 AFM, 5301 Stevens Creek Blvd, United States). A piece of the membrane was fixed on a glass support, and the surface roughness was measured by taking the average amplitude of the cantilever used during measurement. To dig more into the surface features of the support and PPy@TiO₂/PVDF membrane, scanning electron microscopy (SEM; JEOL, Akishima, Tokyo 196-8558, Japan) was carried out. Before the SEM analysis, the membrane pieces were dried and coated in gold for 30 seconds. Energy dispersive X-ray (EDX) and mapping analysis of the supports and PPy@TiO₂/PVDF membrane were carried out to find out the elemental composition.

Permeation of experiments of PPy@TiO₂/PVDF membrane Dead-end filtration mode was used to test the O/W emulsion separation potential of the PPy@TiO₂/PVDF membrane. Different types of feeds were prepared using motor oil (MO), diesel oil (DO), and crude oil (CO) with varying concentrations of oil at 50 ppm, 100 ppm, and 200 ppm. The permeate flux and oil/water (O/W) emulsion separation efficiency was determined to evaluate the performance of the PPy@TiO₂/PVDF membrane.

The polymeric organic/inorganic nanocomposite membrane was fabricated by incorporating TiO₂ in the PVDF matrix during phase inversion, followed by oxidative growth of the polymeric active layer of PPy. The presence of TiO₂ nanoparticles in the PVDF matrix led to a strong interaction between the PPy layer and PVDF, which is attributed to hydrogen bonding between the N—H of pyrrole moiety and the oxygen of TiO₂NPs. The C—F bond of PVDF also acts as a hydrogen bond acceptor to the N—H of the pyrrole moiety. The possible structure and hydrogen bonding interactions are shown in FIG. 2B.

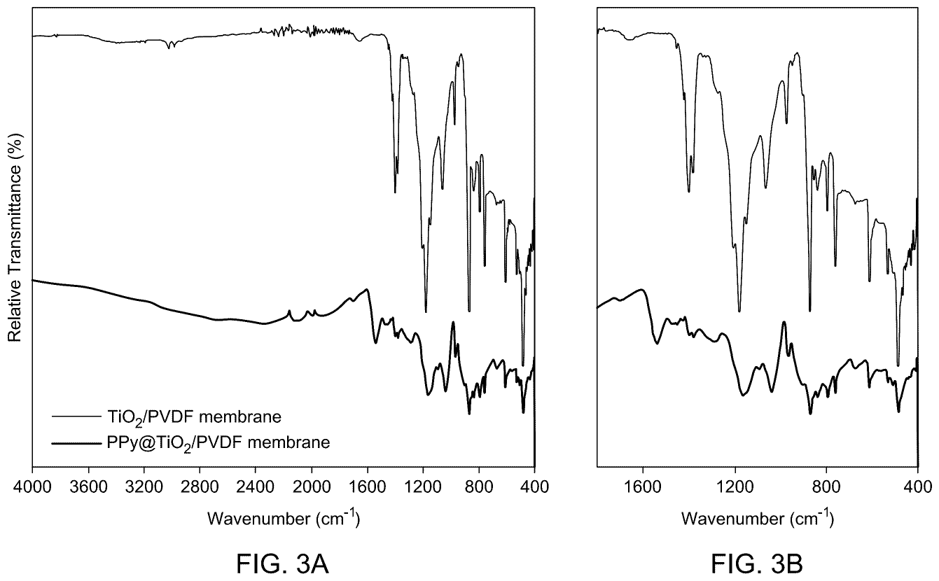

One of the characteristic identifications of the structure of materials is the presence of specific functional groups, which are identified through FTIR. In the case of both the support and the membrane, full ATR-FTIR spectrum and a fingerprint region of the ATR-FTIR spectrum were recorded as given in FIG. 3A and FIG. 3B, respectively. The presence of the TiO₂ was identified by a sharp and deep band at 480 cm⁻¹, which is attributed to the bending mode of the Ti-O bond. The peaks at around 760 cm⁻¹ and 840 cm⁻¹ represents a and R phases of PVDF, in addition to peaks at 1220 cm⁻¹ and 1400 cm⁻¹. These peaks were also found in the case of PPy@TiO₂/PVDF membrane. In the PPy@TiO₂/PVDF membrane spectra, a new peak appeared at around 1550 cm⁻¹ which is attributed to a characteristic vibration band of the pyrrole ring.

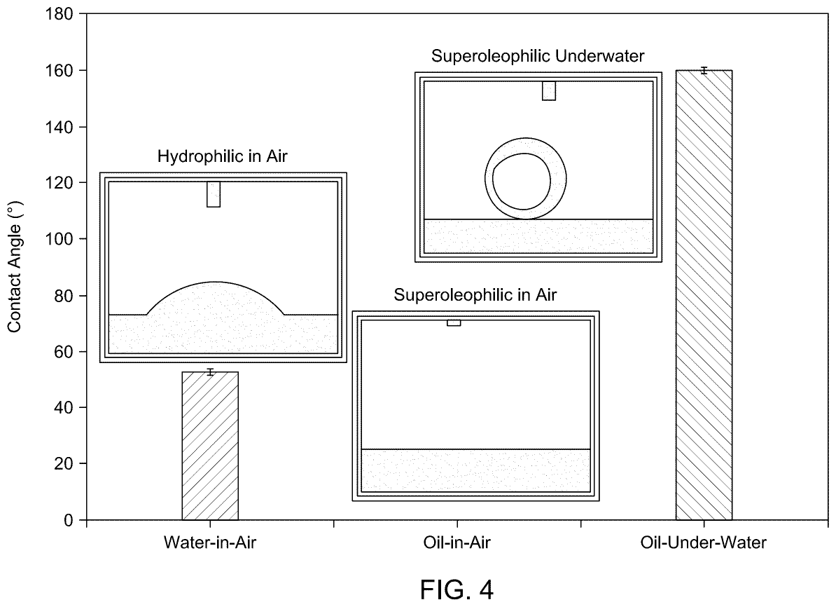

To understand the surface chemistry of the membrane, both water and oil contact angles were measured in air and underwater media (FIG. 4). The water contact angle (WCA=θ_{w,a}) in air revealed the hydrophilic nature of the PPy@TiO₂/PVDF membrane as WCA reached a value of 52.7°. Similarly, the oil contact angle (OCA=θ_{o,a}) of the PPy@TiO₂/PVDF membrane in air revealed the superoleophilic nature of the membrane. The value of θ_{o,a} was found to be 0°. When the oil contact angle was studied underwater (θ_{o,w}), the measurement was found to be >160° indicating the underwater superoleophobic nature of the PPy@TiO₂/PVDF membrane. These observations of varying hydrophilicity behavior of the membrane may be attributed to the presence of several components in the membrane. The hydrophilic nature of the PPy@TiO₂/PVDF membrane may be attributed to the presence of hydrophilic groups such as oxygen- and nitrogen-containing groups of TiO₂ and PPy. Similarly, the superoleophilic nature of the PPy@TiO₂/PVDF membrane might be due to the porous polymeric layer allowing oil penetration into the membrane in an air medium. The underwater superoleophobic behavior of the PPy@TiO₂/PVDF membrane may be suggested by considering the hydrophilic nature of the membrane. Upon dipping the PPy@TiO₂/PVDF membrane in water, the hydrophilic nature of the membrane allows penetration of water into the membrane, which may provide cushion and rejection to oil, and therefore may block the entry of oil into the membrane.

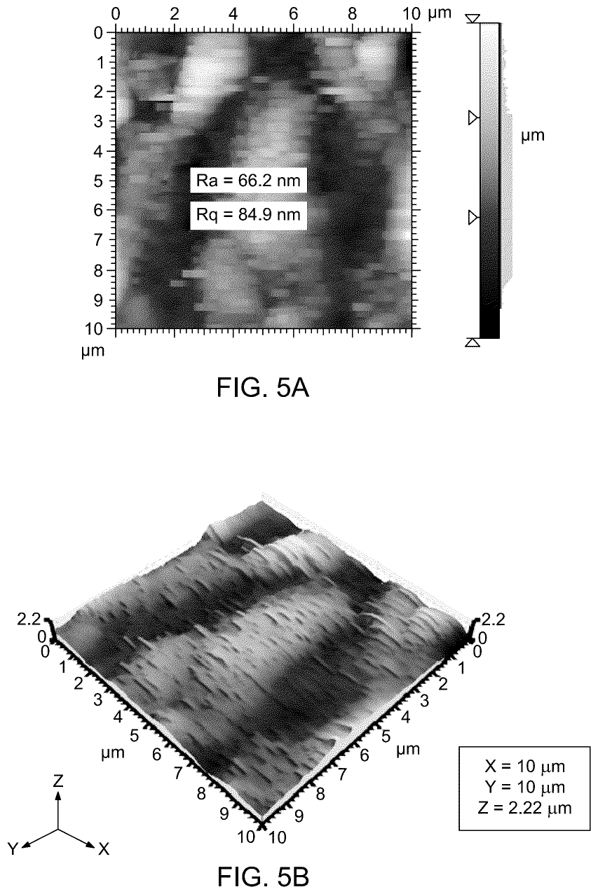

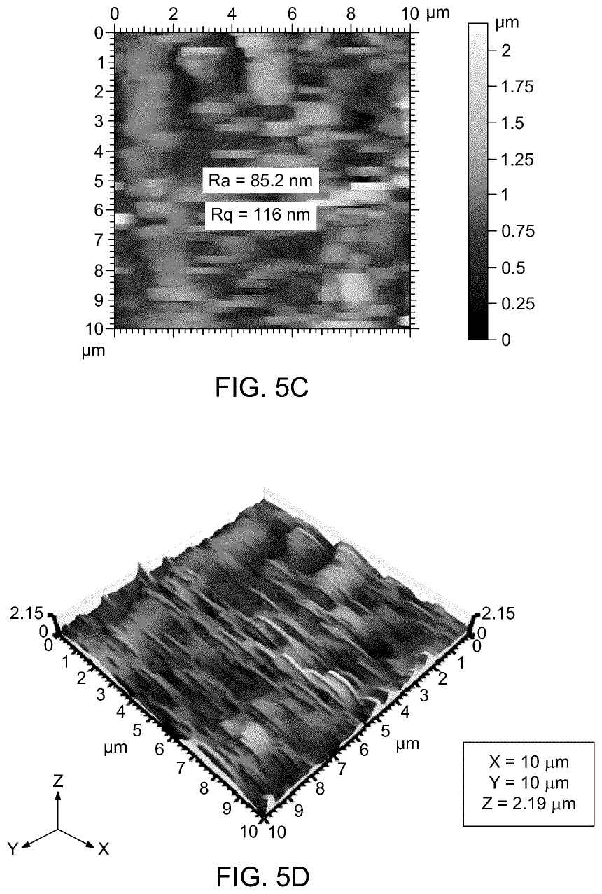

AFM was measured to understand surface features of the PPy@TiO₂/PVDF membrane. The AFM images of the bare TiO₂/PVDF membrane (FIG. 5A and FIG. 5B) and PPy@TiO₂/PVDF membrane (FIG. 5C and FIG. 5D) were measured. It is observed from both 2D (FIG. 5A) and 3D (FIG. 5B) images of the bare TiO₂/PVDF membrane that an average roughness (Rₐ) and a root mean square roughness (R_{q}) were found to be 66.2 nm and 84.9 nm, respectively. However, after the growth of PPy on the bare TiO₂/PVDF membrane, the values of both Ra and R_{q} were increased to values of 85.2 nm and 116 nm, respectively. The increase in surface roughness is also seen in 2D (FIG. 5C) and 3D (FIG. 5D) images of the PPy@TiO2/PVDF membrane. The increase in surface roughness of the PPy@TiO₂/PVDF membrane can be attributed to the polymeric growth of PPy on the bare TiO₂/PVDF membrane.

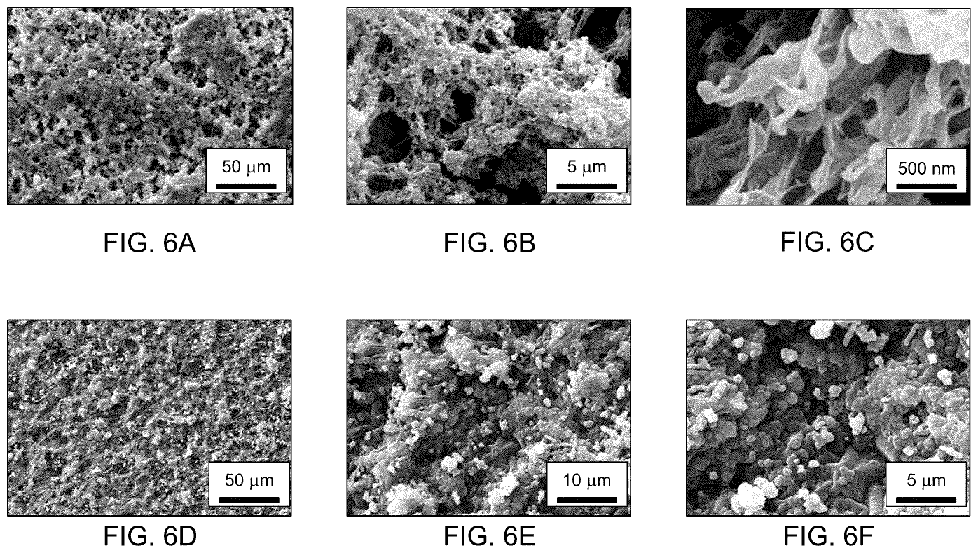

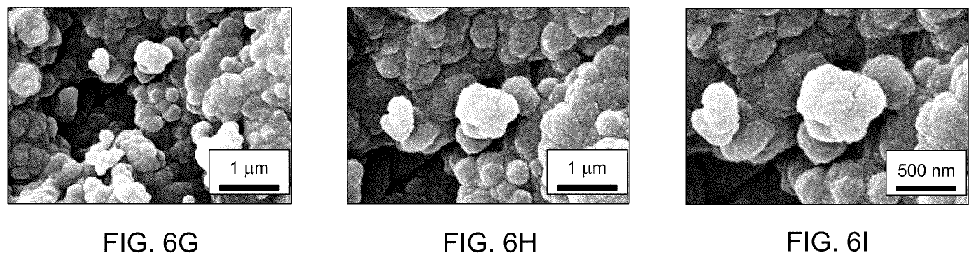

One of the features of membrane surface characterization is the surface morphology of the membrane. SEM analysis of the bare TiO₂/PVDF membrane and PPy@TiO₂/PVDF membrane was carried out to understand the surface morphologies of the membranes. A highly porous bare TiO₂/PVDF membrane can be seen in FIG. 6A and FIG. 6B. A sponge-like pattern is visible in the bare TiO₂/PVDF membrane (FIG. 6A to FIG. 6C), which can be attributed to the wet phase inversion of the PVDF dope solution. The presence of porous sponge-like channels provides a feasible passage for permeate to pass through the membrane. Furthermore, the channels of the bare TiO₂/PVDF membrane are decorated with TiO₂ nanoparticles which offer a hydrophilic nature of the membrane, developing a strong attraction for water molecules. Upon oxidative polymerization of the pyrrole monomer, the spongy nature of the PPy@TiO₂/PVDF membrane is altered, which can be attributed to the development of a PPy layer on the TiO₂/PVDF membrane (FIG. 6D-6I). The globular nature of PPy is evident in high-resolution micrographs (FIG. 6G to FIG. 6I). The presence of globules in the PPy@TiO₂/PVDF membrane support the success of oxidative polymerization of pyrrole monomer, leading to the development of an efficient separation layer.

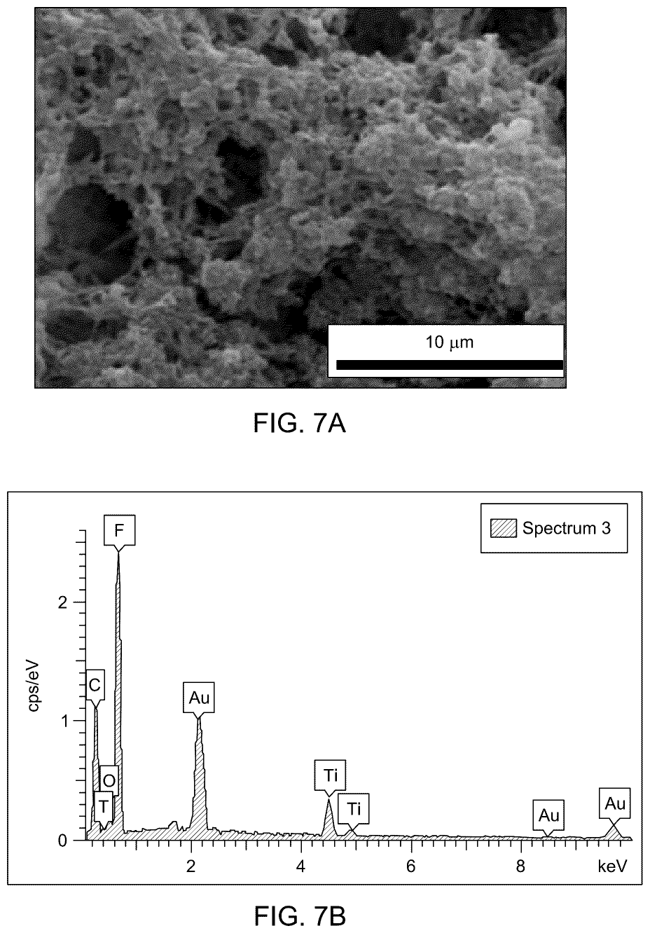

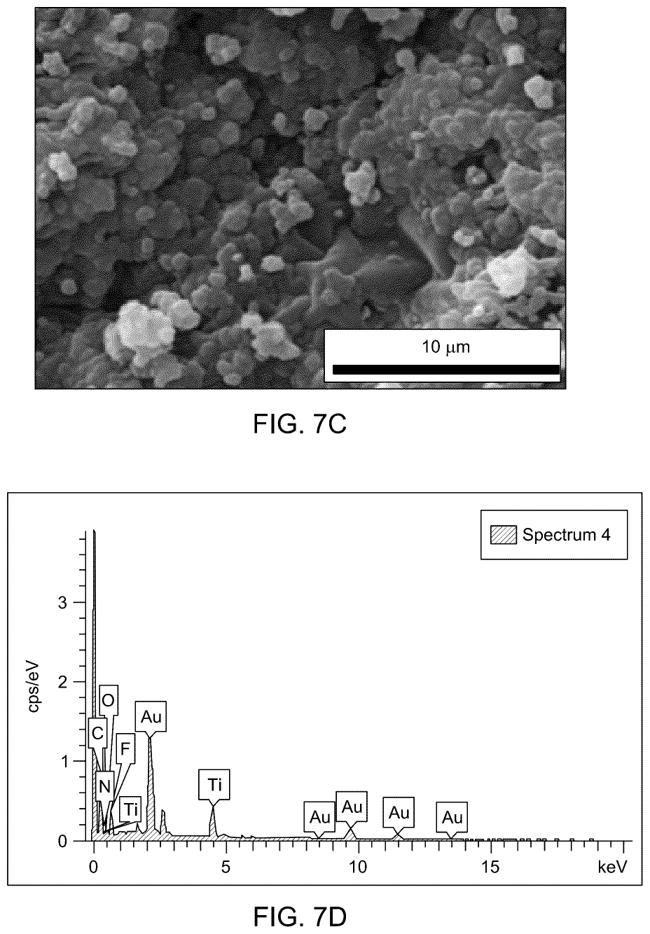

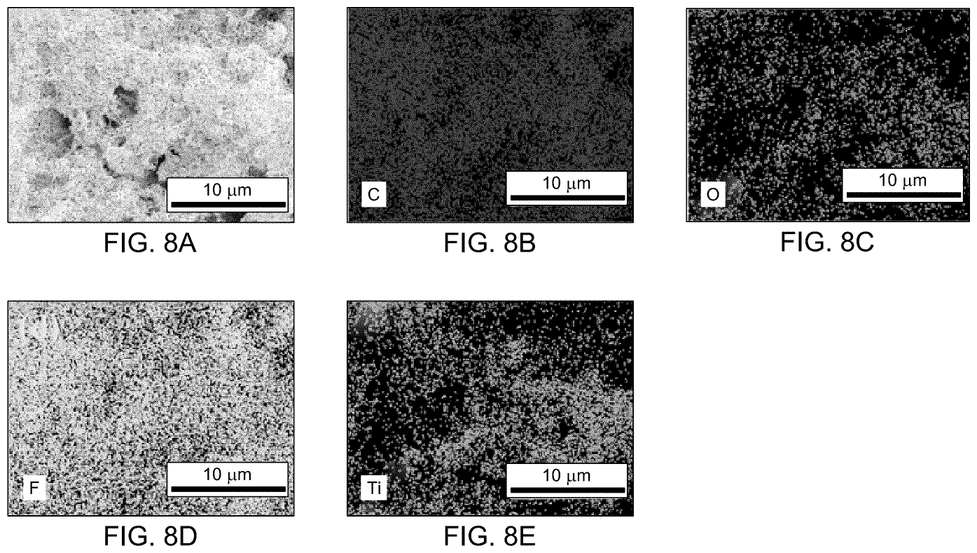

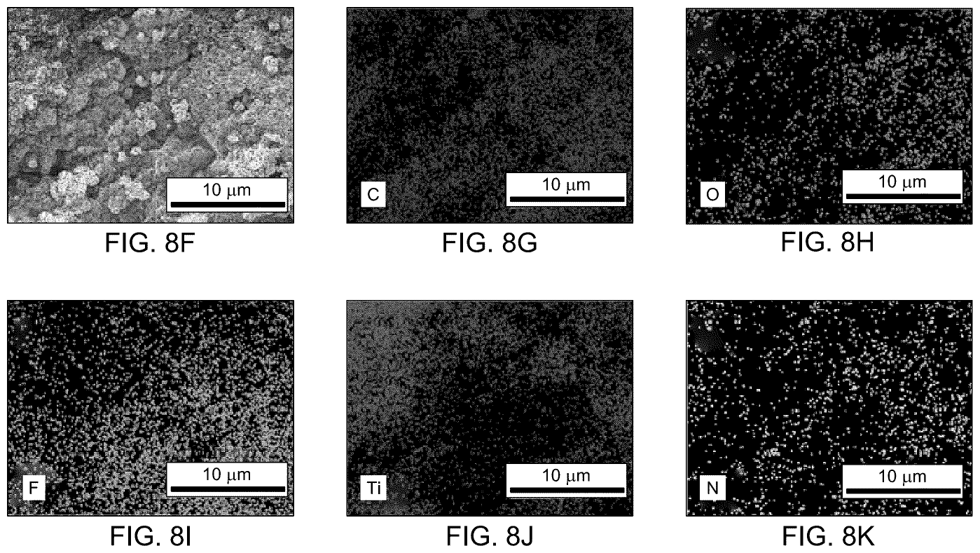

EDX analysis of bare TiO₂/PVDF membrane (FIG. 7A and FIG. 7B) and PPy@TiO₂/PVDF membranes (FIG. 7C and FIG. 7D) showed the surface elemental composition of the membranes. The EDX layered image of the bare TiO₂/PVDF membrane is depicted in FIG. 8A, and the EDX analysis of the TiO₂/PVDF membrane confirmed the presence of the constituent elements, including carbon (C), oxygen (O), fluoride (F), and titanium (Ti), as shown in FIG. 8B to FIG. 8E, respectively. Similarly, the EDX layered image of the PPy@TiO₂/PVDF membrane is depicted in FIG. 8F, and the EDX analysis of the PPy@TiO₂/PVDF membrane indicated the presence of the previously mentioned elements, namely C, O, F, Ti, along with nitrogen (N), in the polyamide active layer on PPy@TiO₂/PVDF membrane, as shown in FIG. 8G to FIG. 8N, respectively.

### Evaluation of Oil/Water Emulsion Separation Performance

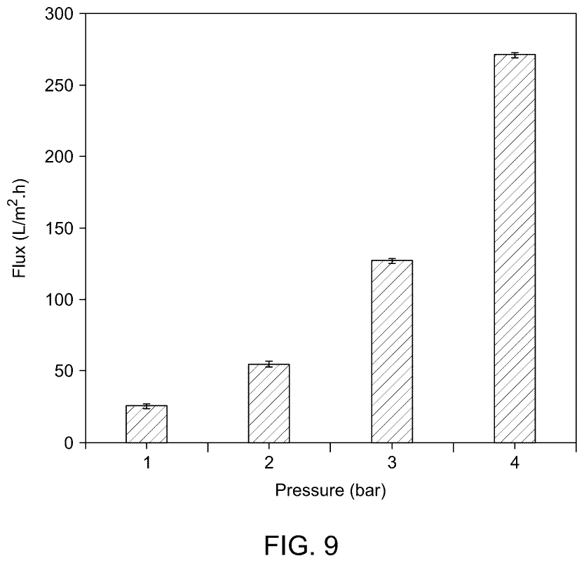

Following thorough characterization and establishing the structure of the PPy@TiO₂/PVDF membrane, the oil/water emulsion separation potential of the membranes was explored. As the feed pressure was increased from 1 bar to 4 bar, the pure water permeate flux was also raised from 25 L m⁻² h⁻(LMH) to 280 LMH (FIG. 9). This behavior of the PPy@TiO₂/PVDF membrane reflects the stability of the membrane under applied filtration conditions.

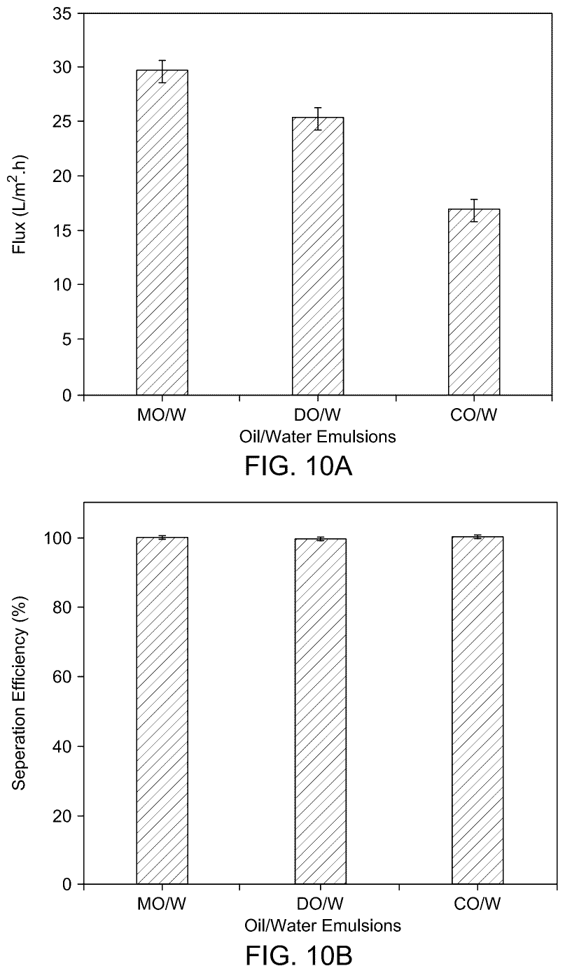

Different types of oils were used as feed to investigate further the potential of PPy@TiO₂/PVDF membrane for oil/water emulsion separation. Other oil feeds were prepared by dissolving an appropriate amount (200 ppm) of oil in water. It was found that flux decreased with changing the chemistry and matrix of the feed oil. Crude oil (CO) has a highly complex matrix and hence offers more chances of fouling. The other oils, such as motor oil (MO) and diesel oil (DO), are just fractions of crude oil, and the chances of developing the fouling layer over the membrane surface are lesser compared to CO, which leads to an increase in permeate flux. MO showed the highest permeate flux of 29 LMH, followed by DO and CO with permeate fluxes of 25 LMH and 17 LMH, respectively, at a pressure of 2 bar (FIG. 10A). The separation efficiency of the PPy@TiO₂/PVDF membrane remained considerably high. In the case of the tested feeds containing MO, DO, and CO, the rejection was found to be >99% (FIG. 10B). This high separation efficiency of PPy@TiO₂/PVDF membrane may be attributed to the oxidative polymerization of pyrrole (Py) yielding a PPy active layer as confirmed by AFM (FIG. 5) and SEM (FIG. 6) images. The underwater superoleophobicity of the PPy@TiO₂/PVDF membrane leads to the rejection of oil while allowing the water to permeate through the membrane.

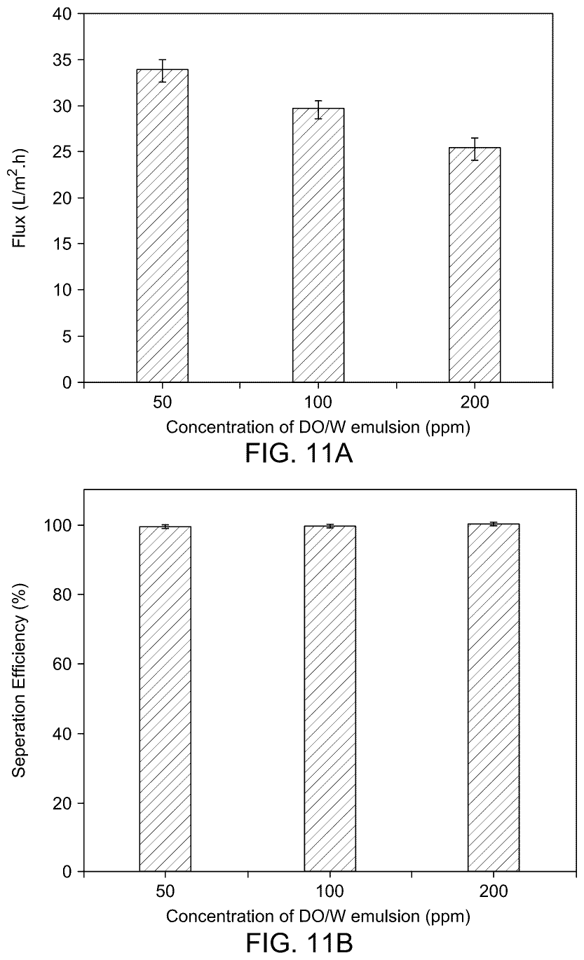

Another aspect of oil/water emulsion separation experiments is the varying concentration of oil in the feed. The impact of increasing DO concentration (50, 100, and 200 ppm) in the oil/water emulsion was also studied. It was found that with an increasing oil concentration in the feed, the flux of the permeate was gradually decreased, which can be attributed to the building of a fouling layer on the PPy@TiO₂/PVDF membrane (FIG. 11A); however, the separation efficiency of the PPy@TiO₂/PVDF membrane remained nearly constant for all of the tested feed types (FIG. 11B). These findings suggest that PPy active layer could reject even higher concentrations of oils in the feeds at lower fluxes.

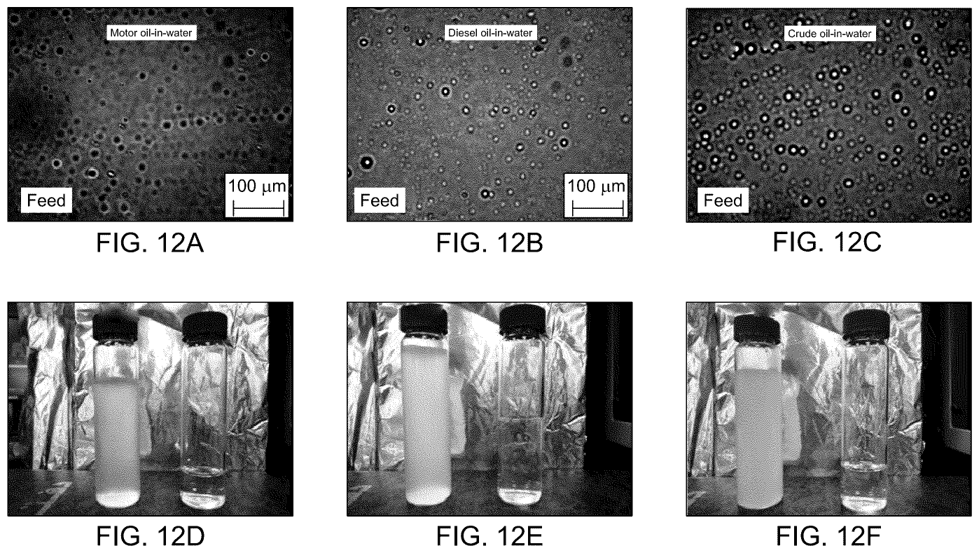

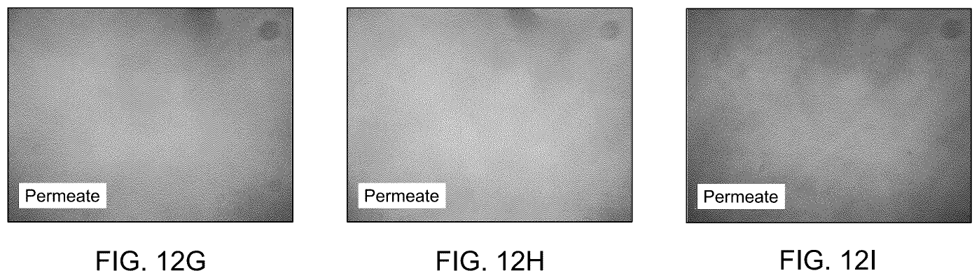

To support the separation of oil from the oil-water emulsions, the micrographs and photographical images of the feeds and permeates were taken and the results are shown in FIG. 12. The feeds of different oils, including MO, DO, and CO, possess a large number of emulsified oil droplets (FIGS. 12A-12C). Although the oil concentrations in the different feeds were the same, the compositions of oil/water emulsions appeared different under the optical microscope. This variation in the composition of oil/water emulsions reflect the different compositions of oils (MO, DO, and CO). The MO oil/water emulsion appeared to have a lesser number of oil droplets (FIG. 12A), while in the case of DO, the emulsion possessed slightly more oil droplets (FIG. 12B). However, in the case of CO oil/water emulsion, the concentration of droplets was the highest (FIG. 12C) compared to the other oils of MO and DO. Since the CO contains the greatest number of petroleum products, including long-chain hydrocarbons and polyaromatic hydrocarbons, which generate a large number of bigger-sized oil droplets in the emulsion, compared to MO and DO. The variation in compositions of different oil emulsions is also seen in visual images (FIG. 12D-FIG. 12F). This variation in the composition of different oil/water emulsions is indicative of the variation of flux and rejection during the oil/water emulsion separation filtration experiments (FIG. 10). A visual inspection of photographical images of the feeds and permeates also revealed that permeate-containing vials were clear of any turbidity and cloudiness compared to that of the feed-containing vials (FIG. 12D-FIG. 12F). The micrographs of permeate are shown in the following FIG. 12G-FIG. 121, which shows that permeates are clear of any oil droplets. The absence of cloudiness and turbidity in permeates support the separation of oil from water.

### Mechanism of O/W Emulsion Separation

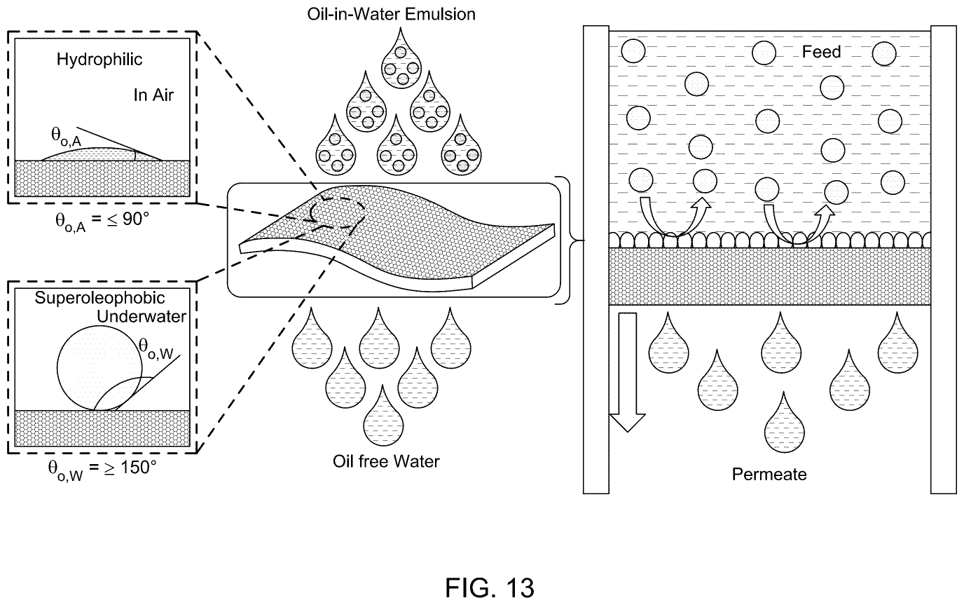

The O/W emulsion separation can be understood by considering the surface wettability of the PPy@TiO₂/PVDF membrane. Owing to the presence of superhydrophilic TiO₂ NPs and the hydrophilic nature of PPy, the PPy@TiO₂/PVDF membrane was rendered as hydrophilic and underwater superoleophobic. The hydrophilic and underwater superoleophobic nature of the PPy@TiO₂/PVDF membrane was established based on contact angle (CA) measurements as the underwater oil contact angle (0,) was measured to be >160°, which support the underwater superoleophobic nature of the PPy@TiO₂/PVDF membrane. Given the hydrophilic nature of the PPy@TiO₂/PVDF membrane, the membrane developed a strong hydration layer. The presence of a continuous and strong hydration layer can be attributed to the development of hydrogen bonding. There are numerous hydrogen sites available for water to interact with which may be between the oxygen atom of TiO₂, while another possible site can be a hydrogen bond between water and the N—H group of PPy. The strong hydration layer of water molecules repels the oil droplets from the membrane surface, and the oil cannot wet the membrane surface, leading to the separation of oil from water. The clean water is permeated through PPy@TiO₂/PVDF membrane while the oil is repelled from the membrane, as demonstrated in FIG. 13.

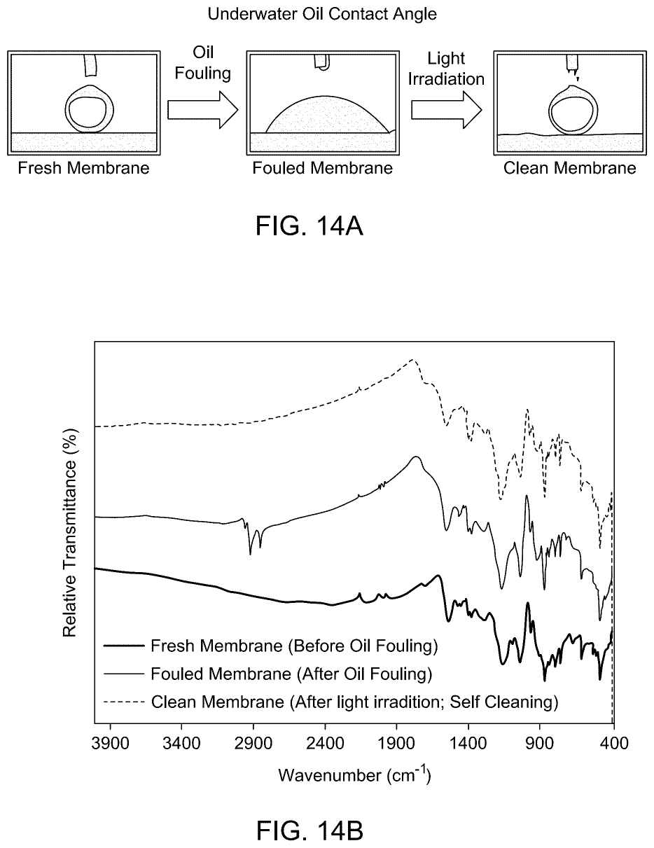

Although the membrane surface is hydrophilic and underwater superoleophobic, membrane fouling is inevitable due to the highly complex nature of oily feeds. Where most of the oil is rejected, certain components of oily feeds can wet the membrane surface under applied transmembrane pressure. Moreover, the dead-end mode of filtration also aggravates the membrane surface fouling. Hence, the development of a fouling layer or cake over the membrane surface over time that decreases the performance of the membrane, especially the volume of permeate flux is reduced. Therefore, membrane surface cleaning is desired to restore the membrane performance over time. Self-cleaning membranes such as the PPy@TiO₂/PVDF membrane are desirable as no external agents are desired to clean the membrane surface. As the active layer of the PPy@TiO₂/PVDF membrane is composed of photocatalytic nanocomposite PPy@TiO₂, the PPy@TiO₂/PVDF membrane was readily able to self-clean on exposure to simulated visible solar light. In order to establish the photocatalytic self-cleaning potential of the PPy@TiO₂/PVDF membrane, underwater oil contact angles (OCAs) of fresh, fouled, and cleaned PPy@TiO₂/PVDF membrane were measured and compared, as shown in FIG. 14A. In the case of fouled PPy@TiO₂/PVDF membrane, the underwater OCA was decreased from >160° to 80°. Upon exposure of the PPy@TiO₂/PVDF membrane to visible light for 1 hour, OCA was restored to its original value of >160° (FIG. 14A). The restoration of OCA of PPy@TiO₂/PVDF membrane indicate the self-cleaning potential of the membrane. The self-cleaning of the PPy@TiO₂/PVDF membrane was further confirmed by ATR-FTIR of fresh, fouled, and self-cleaned PPy@TiO₂/PVDF membrane (FIG. 14B). ATR-FTIR fouled PPy@TiO₂/PVDF membrane showed the presence of oil indicated by two peaks located at 3000 cm⁻¹ and 2900 cm⁻¹ which are attributed to the deposition of aromatic and aliphatic hydrocarbons of O/W emulsion. However, after self-cleaning, the ATR-FTIR of the cleaned membrane resembled the FTIR spectrum, with the disappearance of the two peaks located at 3000 cm⁻¹ and 2900 cm⁻¹, of fresh PPy@TiO₂/PVDF membrane.

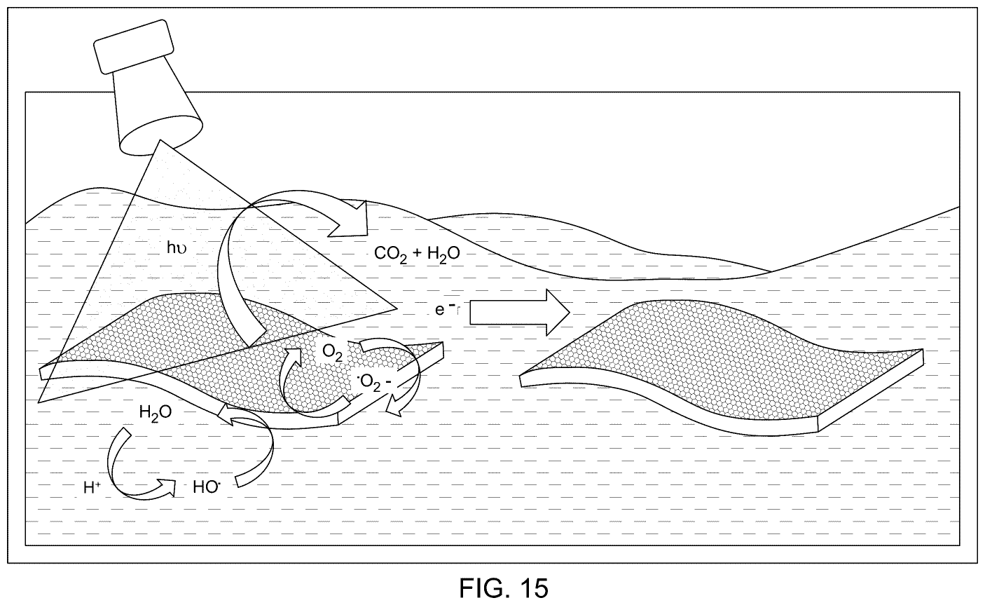

A self-cleaning experiment is demonstrated in FIG. 15. As the PPy@TiO₂/PVDF membrane is exposed to light sources, the deposited oil is photo-catalytically degraded into CO₂ and H₂O. During photocatalysis, a pair of electrons (e⁻) and protons (H⁺) is created, which takes part in the redox reactions, including the reduction of oxygen and oxidation of water. These redox reactions lead to the generation of highly reactive oxygen species such as superoxide (02) and hydroxide (OH⁻). These species may recombine before taking part in redox reactions, resulting in a deceased efficiency of the photocatalyst. The separation of this pair contributes to the photocatalytic activity. In the case of PPy@TiO₂, the TiO₂ absorbs in the UV range due to its bandgap of 3.2 eV. However, PPy@TiO₂ absorbs in the visible region leading to π-π* transitions which, in turn, transfers excited electrons from π* orbital to the conduction band of TiO₂. These electrons are absorbed by the oxygen molecules on the surface of the TiO₂ in PPy@TiO₂/PVDF membrane, generating superoxide radicals which degrade the oil adsorbed on the membrane surface. Similarly, the generated electron holes can also react with water molecules, leading to the generation of hydroxyl free radicals. These radicals react with organic pollutants deposited on the PPy@TiO₂/PVDF membrane, generating CO₂ and H₂O as biocompatible by-products (FIG. 15).

A polymeric-inorganic nanocomposite PPy@TiO₂/PVDF membrane with photocatalytic self-cleaning properties was fabricated to reclaim clean water from oily wastewater feeds. The TiO₂ NPs were dispersed in a coagulation bath and, upon wet phase inversion, the TiO₂ NPs were embedded in the PVDF matrix. The TiO₂@PVDF was used as a substrate to grow the PPy polymer through in-situ oxidative polymerization leading to the establishment of PPy@TiO₂ nanocomposite as an active layer, and the resultant membrane was regarded as PPy@TiO₂/PVDF membrane. The water contact angle in air (WCA=θ_{w,a}) revealed the hydrophilic nature of the PPy@TiO₂/PVDF membrane as WCA reached a value of 52.7°. The underwater oil contact angle (θ_{o,w}), which was measured to be >160°, supported the underwater superoleophobic nature of the PPy@TiO₂/PVDF membrane. In the case of the tested feeds containing MO, DO, and CO, the rejection was found to be >99%. This high separation efficiency of the PPy@TiO₂/PVDF membrane may be attributed to the oxidative polymerization of pyrrole yielding a polypyrrole active layer, as indicated by AFM. A visual inspection of photographic images of all feeds and permeates also revealed that permeate-containing vials were clear of turbidity and cloudiness. In the case of fouled PPy@TiO₂/PVDF membrane, the underwater OCA was decreased from >160° to 80°. Upon exposure of PPy@TiO₂/PVDF membrane to visible light for 1 hour, OCA was restored to its original value of >160°. The PPy@TiO₂/PVDF membrane has potential for cleaning oily wastewater streams with self-cleaning properties.

Numerous modifications and variations of the present disclosure are possible in light of the above teachings. It is therefore to be understood that within the scope of the appended claims, the invention may be practiced otherwise than as specifically described herein.

1: A filtration membrane, comprising:
a first layer comprising a polyester terephthalate nonwoven fabric;
a second layer comprising a polyvinylidene fluoride matrix doped with a polyvinylpyrrolidone and titanium dioxide nanoparticles; and
a third layer comprising a polypyrrole polymer.

2: The filtration membrane of claim 1, wherein one or more amine group of the polypyrrole polymer is bonded to one or more oxygen atom of the titanium dioxide nanoparticles.

3: The filtration membrane of claim 1, wherein the membrane is a porous structure with pores from 0.5 to 10 micrometers (μm) in diameter.

4: The filtration membrane of claim 1, wherein the third layer is in the form of globules wherein the globules have an average diameter of 0.5 to 3 μm.

5: The filtration membrane of claim 1, wherein the membrane has a rate of flux from 20 to 300 liters per square meter per hour (L m⁻² h⁻¹) at a pressure from 0.5 bar to 5 bar.

6: The filtration membrane of claim 1, wherein the membrane has an average surface roughness of 80 to 90 nanometers (nm).

7: The filtration membrane of claim 1, wherein the membrane has a root mean square roughness of 110 to 120 nm.

8: The filtration membrane of claim 1, wherein the membrane has a water contact angle of 50 to 60°.

9: The filtration membrane of claim 1, wherein the membrane has an oil contact angle in air of about 0° and an oil contact angle in water of at least 160°.

10: The filtration membrane of claim 1, wherein the membrane has a rejection profile of oils of at least 99% by weight.

11: The filtration membrane of claim 1, wherein the membrane is self-cleaning under visible light irradiation conditions.

12: The filtration membrane of claim 11, wherein the visible light irradiation is for at least a time of 1 hour.

13: A method of filtration, comprising:
contacting the filtration membrane of claim 1 with an oil-water composition,
wherein the oil-water composition comprises at least water and one or more oil,
collecting a permeate passing through the filtration membrane to obtain a purified composition have a reduced amount of the oil.

14: The method of claim 13, wherein the oil in the oil-water composition is one or more of motor oil, diesel oil, and crude oil.

15: The method of claim 13, further comprising:
wetting the filtration membrane with water before contacting the filtration membrane with the oil-water composition.

16: The method of claim 13, wherein a mechanism of the method of filtration comprises coating the membrane with a layer of water before rejecting the oil.

17: The filtration membrane of claim 1, wherein the membrane was made by a process, comprising:
dissolving a polyvinylidene fluoride and a polyvinylpyrrolidone in an organic solvent to form a polyvinylidene fluoride dope solution;
casting the polyvinylidene fluoride dope solution onto the polyester terephthalate nonwoven fabric,
wherein the polyester terephthalate nonwoven fabric is prefixed to a glass plate;
immersing the polyester terephthalate nonwoven fabric cast with the polyvinylidene fluoride dope solution in a first solution of titanium dioxide nanoparticles in an alcohol to form a first material; and
contacting the first material with a second solution of a pyrrole monomer, a sodium dodecyl sulfate, and an inorganic salt in water to form the filtration membrane.

18: The filtration membrane of claim 1, wherein the titanium dioxide nanoparticles are incorporated into the polyvinylidene matrix in a phase inversion process.

19: The filtration membrane of claim 1, wherein the polypyrrole polymer is deposited on the titanium dioxide nanoparticles in a chemical oxidation process to form a polymeric active layer of the polypyrrole polymer on the titanium dioxide nanoparticles.

20: The method of claim 13, further comprising:
irradiating the membrane with visible light thereby photo-catalytically degrading oil deposited on the membrane during the collecting to form carbon dioxide.
